(19) United States
(12) Patent Application Publication
(10) Pub. No.: US 2008/0049062 A1
(43) Pub. Date: Feb. 28, 2008

(54) Printer and printing method

(75) Inventor: Hitoshi Igarashi, Shiojiri-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/881,322

(22) Filed: Jul. 26, 2007

(30) Foreign Application Priority Data
Jul. 26, 2006 (JP) 2006-202918

(51) Int. Cl. B41J 29/38

(52) U.S. Cl. 347/16

(57) ABSTRACT

A printer that performs printing on a print target includes a motor, a storage device, a measurement control device, a corrected output power calculating device, and a corrected output power applying device. The motor applies a driving force for transporting a transport object. The storage device stores reference information relating to reference stop characteristics of the motor. The measurement control device controls driving of the motor for measuring actual stop characteristics of the motor. The corrected output power calculating device outputs a corrected output power by comparing the actual stop characteristics with the reference stop characteristics when the measurement control device controls driving of the motor. The corrected output power applying device outputs the corrected output power to the motor so that a stop condition of stopping the transport object is satisfied.

### BACKGROUND

1. Technical Field

The present invention relates to a printer and a printing method.

2. Related Art

Some ink jet printers include a plurality of DC motors. An ink jet printer of this type controls driving of the DC motors so as to transport a print target and to move a carriage on which a print head is mounted. In recent years, further improved print quality has been required for ink jet printers. In response to the above requirement, the size of ink droplets is becoming increasingly small. In order to direct such small ink droplets onto desired positions, it is necessary to improve the accuracy of positioning a stop position of the print target.

Japanese Unexamined Patent Application Publication No. 2001-251878 describes an example which attempts to improve the accuracy of positioning a stop position of the print target. The above publication specifically describes a technology in which a speed measurement position is set at a position located a predetermined distance before a target stop position and, when a driven object arrives at the speed measurement position, electric current supplied to a motor is interrupted at the time when a period of time corresponding to a current speed of the motor has elapsed. In addition, in the description of the above publication, the edges of the scale of an encoder are detected, and a moving speed of the print target is calculated on the basis of the number of pulses obtained as a result of the detection. Then, a deviation is calculated between the moving speed and a target speed and, on the basis of the deviation, the operation for PID (proportional integral derivative) control is executed. After that, a new duty ratio obtained as a result of the operation is applied to the motor, thus making it possible to have the moving speed of the print target following the target speed.

Incidentally, in the technology described in Japanese Unexamined Patent Application Publication No. 2001-251878, the time when electric current supplied to the motor is interrupted is determined in consideration of a variation in speed. In general, in comparison with interruption of the supply of electric current when the rotational speed of a motor is high, when the supply of electric current is interrupted during times when the rotational speed of the motor is low, the electric current is interrupted in a state where a distance per unit time with which the print target is transported is small, and the period of time until the print target is stopped is also short. Hence, the accuracy of positioning is improved. Then, one method may be conceived, in which, after the transport speed of the print target is decreased, electric current supplied to the motor is interrupted, thus improving the accuracy of positioning. With this method, the accuracy of positioning is improved.

Here, a method may be employed for an existing printer, in which, when the print target is stopped at a target position, for example, PID control is executed up to a predetermined position slightly before the target position and electric current supplied to the motor is interrupted after the print target arrives at the predetermined position. In this case, the print target proportionally decreases from the speed immediately before it stops by a predetermined deceleration due to a frictional force generated at the moving portions and finally stops around the target position. Note that, in this case, characteristics regarding a frictional force (stop characteristics) are preferably stored in advance as prescribed values in a memory, or the like, of the printer.

Meanwhile, in a printer, it is highly likely for the stop characteristics to vary according to changes in an external environment, changes over time in power transmitting portions and/or sliding portions, or the like. Then, even when the supply of electric current is interrupted at the same position (same timing) as that before the stop characteristics varied, a position at which the print target actually stops is deviated from the stop position at which the print target stops before the stop characteristics varied. Therefore, although the print target stops around the target position initially just after the printer is purchased, as the printer is used for a long time, there will be a problem in that the print target will stop at a position that is significantly deviated from the target position.

Such a drawback is not removed using the technology described in the above publication. In addition, even when the way in which the supply of electric current is interrupted after the transport speed of the print target is decreased is combined with the technology described in the above publication, the above described drawback is still not removed.

Moreover, when the transport speed of the print target is an assumed speed or above as well, there is a problem in that the print target stops at a position that is deviated from the target position.

### SUMMARY

An advantage of some aspects of the invention is that it provides a printer and a printing method, that are capable of improving the accuracy of a stop position at which a transport object stops even when the stop characteristics of a motor vary.

A first aspect of the invention provides a printer that performs printing on a print target. The printer includes a motor, a storage device, a measurement control device, a corrected output power calculating device, and a corrected output power applying device. The motor applies a driving force for transporting a transport object. The storage device stores reference information relating to reference stop characteristics of the motor. The measurement control device controls driving of the motor for measuring actual stop characteristics of the motor. The corrected output power calculating device outputs a corrected output power by comparing the actual stop characteristics with the reference stop characteristics when the measurement control device controls driving of the motor. The corrected output power applying device outputs the corrected output power to the motor so that a stop condition of stopping the transport object is satisfied.

With this configuration, when the measurement control device controls driving of the motor, the corrected output power calculating device compares the actual stop characteristics with the reference stop characteristics and the corrected output power is then calculated. This corrected output power is output so that the stop condition of the transport object is satisfied. Therefore, for example, even when the printer is used for a long time and the stop characteristics then vary, it is possible to stop the motor so as to follow the predetermined stop characteristics. In this manner, even when the printer is used for a long time, it is possible to stop the transport object at a position that is not significantly deviated from the target position and possible to ensure the accuracy of the stop position. In addition, it is not necessary to, for example, decrease the rotational speed of the motor in order to improve the accuracy of the stop position, so that it is possible to improve throughput.

In the above first aspect of the invention, the corrected output power applying device, when the motor is being driven, may estimate a stop position, at which the transport object that is transported by the motor stops, on the basis of current speed information relating to the motor and the reference stop characteristics, and, when it is determined that the stop condition is satisfied, that is, the estimated stop position is equal to or beyond a target stop position of the transport object, the corrected output power applying device may interrupt electric current for driving the motor and output the corrected output power to the motor.

With this configuration, the corrected output power applying device estimates a stop position of the transport object on the basis of the current speed information relating to the motor and the reference stop characteristics. Therefore, it is possible to estimate a stop position of the transport object, irrespective of the current rotational speed (the number of rotations) of the motor, and it is possible to ensure the accuracy of a stop position of the transport object. In addition, because it is determined that the stop condition is satisfied, that is, the estimated stop position of the transport object is equal to or beyond a target stop position of the transport object, it is possible to prevent such a drawback that the transport object stops immediately before the target stop position and the transport object thereby cannot be delivered.

The printer, in addition to the above configuration, may further include a motor drive control device and a position detection device, wherein, when the motor is being driven, the motor drive control device executes PID control on the motor, a PID calculation is performed by the PID control every predetermined period, the position detection device detects a feed amount by which the motor feeds the transport object, wherein the position detection device outputs a detection signal, which is a digital signal, to the motor drive control device, and wherein the motor drive control device interrupts electric current supplied through the PID control when the estimated stop position is equal to or beyond the target stop position.

With this configuration, the motor drive control device interrupts electric current supplied through the PID control when the estimated stop position is equal to or beyond the target stop position on the basis of the detection signal input from the position detection device. After the interruption of supply of electric current, because the corrected output power is output, it is possible to ensure the accuracy of a stop position of the transport object. In addition, it is possible to prevent such a drawback that the transport object stops immediately before the target stop position and the transport object thereby cannot be delivered.

In the above configurations, the measurement control device may measure the actual stop characteristics when the printer is turned on, that is, an initial start-up of the printer. With this configuration, when the printer is turned on, the measurement control device measures the actual stop characteristics of the motor. Therefore, a printing operation is not interrupted as compared with the case where the actual stop characteristics is measured during a printing operation, and the throughput is not influenced.

Furthermore, in the above configuration, the corrected output power calculating device may calculate the corrected output power by comparing an actual duty ratio by which the motor is driven at a target speed with a reference duty ratio that correlates with the reference stop characteristics.

With this configuration, it is possible to calculate the corrected output power in response to the actual driving of the motor by comparing a duty ratio by which the motor is driven at a target speed with a reference duty ratio.

In addition, in the above configuration, the corrected output power calculating device may calculate the corrected output power by comparing an actual speed at which the motor is driven by a constant duty ratio with a reference speed that correlates with the reference stop characteristics.

With this configuration, it is possible to calculate a variation in load on the motor by comparing an actual speed at which the motor is driven by a constant duty ratio with a reference speed.

In the above configurations, the transport object may be a print target, and the motor may be a transporting motor that applies a driving force for transporting the print target.

With this configuration, even when a variation in load on the transporting motor or a variation in speed occurs immediately before the transporting motor stops, it is possible to stop the print target at a target stop position in high accuracy. Therefore, it is possible to improve printing precision. In addition, because it is unnecessary to, for example, decrease the rotational speed of the transporting motor in order to improve the accuracy of a stop position, it is possible to improve throughput over the entire printing process.

A second aspect of the invention provides a printing method that executes printing on a print target. The printing method includes controlling driving a motor, that applies driving force for transporting a transport object, to measure actual stop characteristics of the motor, calculating a corrected output power, when the motor is being driven in the controlling step, by comparing the measured actual stop characteristics with reference stop characteristics stored in a storage device, and outputting the corrected output power, that is calculated in the calculating step, to the motor so that a stop condition of stopping the transport object is satisfied.

With this configuration, when the motor is being driven in the controlling step, a corrected output power is calculated by comparing actual stop characteristics with reference stop characteristics in the calculating step. Then, in the outputting step, the corrected output power is output so that the stop condition of stopping the transport object is satisfied. Therefore, for example, even when the printer is used for a long time and the stop characteristics vary, it is possible to stop the motor so as to follow the predetermined stop characteristics. In this manner, even when the printer is used for a long time, it is possible to stop the transport object at a position that is not significantly deviated from the target position and possible to ensure the accuracy of the stop position. In addition, it is not necessary to, for example, decrease the rotational speed of the motor in order to improve the accuracy of the stop position, so that it is possible to improve throughput.

### BRIEF DESCRIPTION OF THE DRAWINGS

The invention will be described with reference to the accompanying drawings, wherein like numbers reference like elements.

FIG. 1 is a schematic view showing a configuration of a printer according to an embodiment of the invention.

FIG. 2 is a side cross-sectional view showing a portion relating to a paper feed in the printer.

FIG. 3A and FIG. 3B are views showing ENC signals.

FIG. 4 is a block diagram showing a measurement unit and a corrected output power applying unit.

FIG. 5 is a block diagram showing a motor drive control unit.

FIG. 6 is a view showing a relationship in a speed table between speed and time.

FIG. 7 is a view showing a relationship among ENC signal, period of PID calculation, and rotational speed.

FIG. 8 is a flow chart showing an operation of measurement.

FIG. 9A and FIG. 9B are views showing a relationship among speed, position, and electric current.

FIG. 10 is a schematic flow chart showing an overall operation of the printer.

FIG. 11 is a flow chart showing an operation of PF motor in each step.

FIG. 12 is a flow chart showing an operation of deceleration control in detail.

FIG. 13 is a flow chart showing an operation of applying a corrected output power.

### DESCRIPTION OF EXEMPLARY EMBODIMENTS

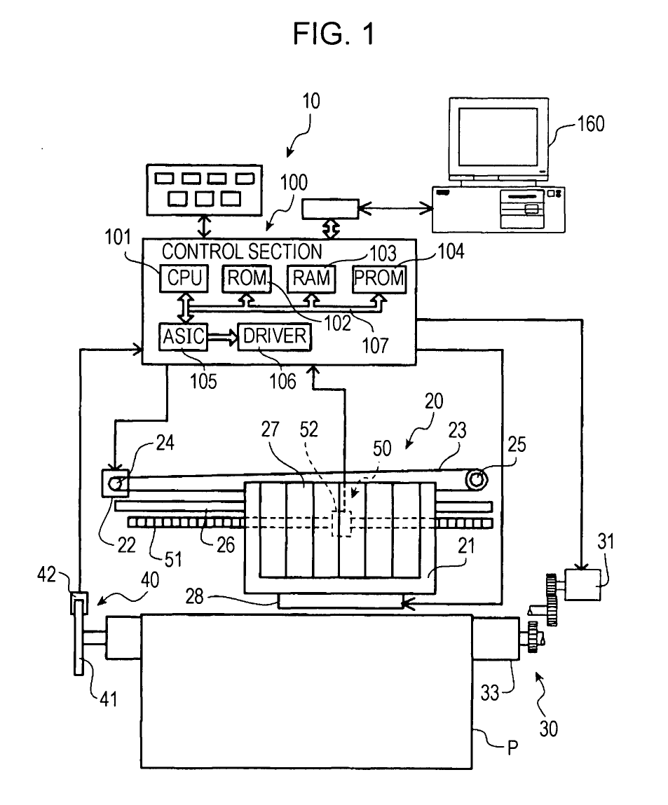

An embodiment of a printer 10 and a printing method according to the invention will be described with reference to FIG. 1 to FIG. 13. Note that the printer 10 of the present embodiment is an ink jet printer; however, the ink jet printer may be a device that employs any liquid discharging method as long as it is a device capable of printing by discharging ink.

In addition, in the following description, the lower side corresponds to a side where the printer 10 is mounted and the upper side corresponds to a side that is located a certain distance away from the side where the printer 10 is mounted. A direction in which a carriage 21, which will be described later, moves is defined as a main scanning direction (an x-coordinate direction), and a direction perpendicular to the main scanning direction and in which a print target P is transported is defined as an auxiliary scanning direction. Furthermore, a side from which the print target P is fed is defined as a paper feed side (rear end side), and a side from which the print target P is delivered is defined as a paper delivery side (front end side).

### Configuration of Printer 10

As shown in FIG. 1, the printer 10 includes a case (not shown), a carriage drive unit 20, a paper transport unit 30, a rotary encoder 40, a linear encoder 50, and a control section 100, as main components.

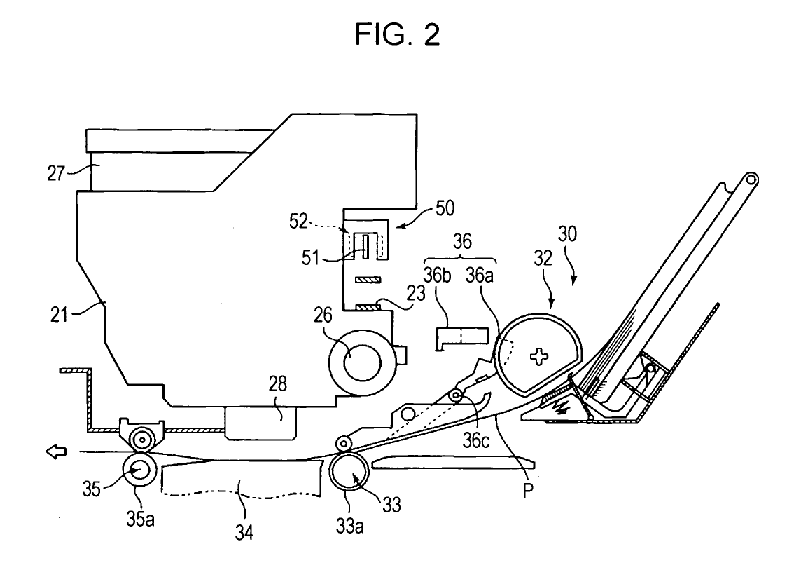

The carriage drive unit 20 includes the carriage 21, a carriage motor (CR motor) 22, a belt 23, a gear pulley 24, a driven pulley 25, and a carriage shaft 26. The carriage 21 allows ink cartridges 27 for respective colors to be mounted thereon. In addition, as shown in FIG. 1 and FIG. 2, a print head 28 that is able to discharge ink droplets is provided on the lower face of the carriage 21. Further, the belt 23 is an endless belt and is partially fixed to the back face of the carriage 21. The belt 23 is wound around the gear pulley 24 and the driven pulley 25.

The print head 28 is provided with columns of nozzles (not shown) corresponding to the respective inks. Piezoelectric elements (not shown) are arranged at positions corresponding to the nozzles that form the columns of nozzles. Ink droplets may be discharged from the nozzles, located at the ends of ink passages, by these piezoelectric elements being operated. Note that the print head 28 is not limited to one of a piezoelectric drive-type that uses piezoelectric elements; the print head 28 may also employ one of, for example, a heater-type that utilizes a force of bubbles generated by heating ink, a magnetostriction-type that uses a magnetostrictor, a mist-type in which ink mist is controlled with an electric field, or the like. In addition, the inks with which the ink cartridges 27 are filled may be of any type, such as dye ink or pigment ink.

As shown in FIG. 1, the paper transport unit 30 includes a PF motor 31 and a paper feed roller 32. The PF motor 31, which serves as a motor and a transporting motor, transports the print target P, which may be regarded as a transport object. The paper feed roller 32 feeds pieces of paper, such as plain paper. In addition, a pair of PF rollers 33 is provided on the paper delivery side relative to the paper feed roller 32 for transporting and pinching the print target P. Further, on the paper delivery side of the pair of PF rollers 33, a platen 34 and the above described print head 28 are arranged one above the other and opposed to each other. The platen 34, which may be regarded as a mounting portion, supports, from its lower side, the print target P that is transported to below the print head 28 by the pair of PF rollers 33. On the paper delivery side relative to the platen 34, a pair of paper delivery rollers 35, which are similar to the pair of PF rollers 33, is provided. Driving force is transmitted from the PF motor 31 to a paper delivery drive roller 35a of the pair of paper delivery rollers 35 and also to a PF drive roller 33a. Note that the CR motor 22 and the PF motor 31 are DC motors.

In addition, the printer 10 is provided with a paper end detection sensor 36. The paper end detection sensor 36 includes a detection lever 36a and a sensor body portion 36b. The detection lever 36a is pivotable about a pivotal shaft 36c provided near the middle of the detection lever 36a. On the other hand, the sensor body portion 36b is located above the detection lever 36a and has a light emitting portion (not shown) and a light receiving portion (not shown) that receives light emitted from the light emitting portion. Then, the upper portion of the detection lever 36a above the pivotal shaft 36c is configured to block or transmit light, that travels from the light emitting portion toward the light receiving portion, by the pivotal action of the detection lever 36a.

Thus, when the detection lever 36a is pressed to pivot upward as the print target P passes, the upper portion of the detection lever 36a moves away from the sensor body portion 36b. In this manner, the light receiving portion enters a light receiving state, thus detecting the passing of the front end of the print target P. On the other hand, as the rear end of the print target P passes the detection lever 36a, the detection lever 36a is pivoted downward to return. In this manner, the light receiving portion is switched to a non-light-receiving state, thus detecting the passing of the rear end of the print target P.

In addition, as shown in FIG. 1, the rotary encoder 40, which may be regarded as a position detection device, includes a disc-shaped scale 41 and a rotary sensor 42. The disc-shaped scale 41 has a light transmitting portion that transmits light therethrough and a light blocking portion that blocks transmission of light. The light transmitting portion and the light blocking portion are arranged along the circumferential direction of the disc-shaped scale 41 at predetermined intervals. The disc-shaped scale 41 is rotated by the PF motor 31.

The rotary sensor 42 has a light emitting element (not shown) and a light receiving element (not shown) as main components. The light emitting element is, for example, formed of a member, such as a light emitting diode, that is capable of emitting light. In addition, a collimator lens (not shown) is located between the light emitting element and the light receiving element. Then, light emitted from the light emitting element passes through the collimator lens to be shaped into parallel light and then enters the disc-shaped scale 41.

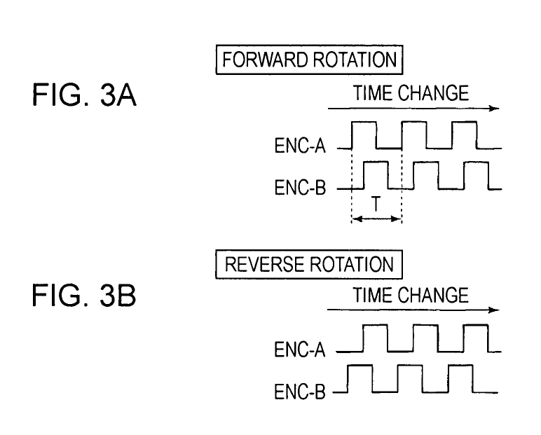

On the other hand, light input to the light receiving element is converted to an electrical signal through predetermined photoelectric conversion and is then processed in a signal processing circuit (not shown). After that, the processed signal is output to a comparator (not shown). The comparator compares each of the input signals and, on the basis of the comparison, outputs pulse signals shown in FIG. 3A and FIG. 3B (A-phase ENC signal, B-phase ENC signal; which may be regarded as detection signals). Here, the output A-phase ENC signal and the output B-phase ENC signal are different in phase by 90 degrees from each other. Therefore, when the CR motor 22 is in a forward rotation state (when the carriage 21 is moving in a direction away from a home position), the A-phase ENC signal is advanced in phase by 90 degrees relative to the B-phase ENC signal. On the other hand, when the CR motor 22 is in a reverse rotation state, the A-phase ENC signal is retarded in phase by 90 degrees relative to the B-phase ENC signal.

The linear encoder 50 has a linear scale 51 that extends along the auxiliary scanning direction of the printer 10 and a photosensor (linear sensor) 52, which is similar to the above described rotary encoder 40. Because the linear encoder 50 has the same structure as the rotary encoder 40 except that the linear scale 51 is formed to be longer, a specific description thereof is omitted.

Note that the printer 10, other than the above described components, further includes other various sensors, such as a paper width detection sensor that detects the width of the print target P and a gap detection sensor that detects a distance between the print head 28 and the platen 34.

### Configuration of Control Section 100

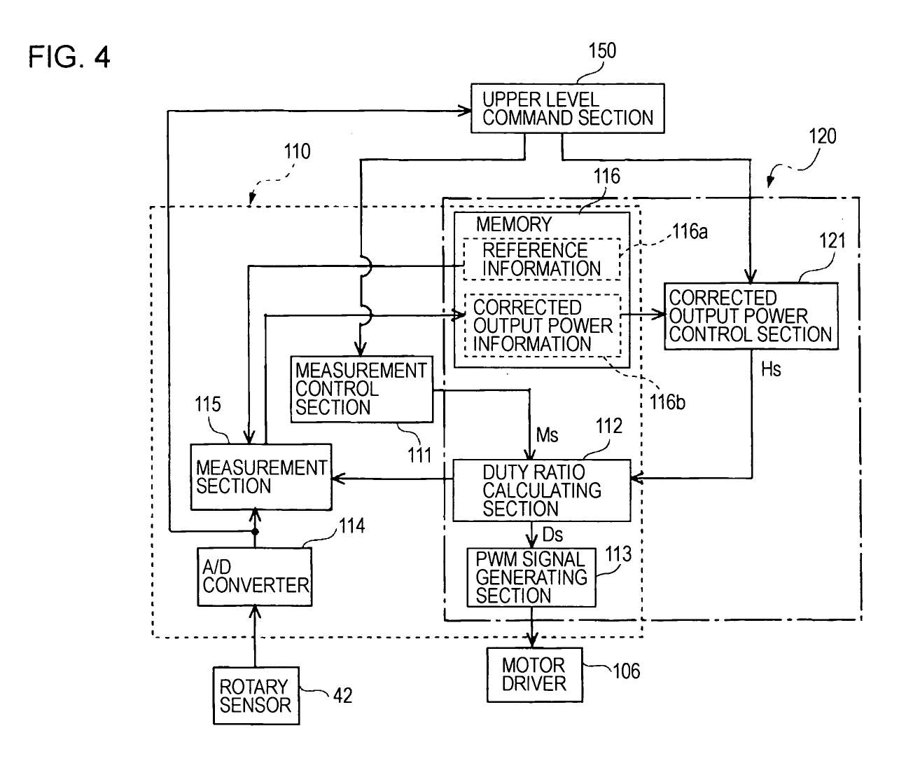

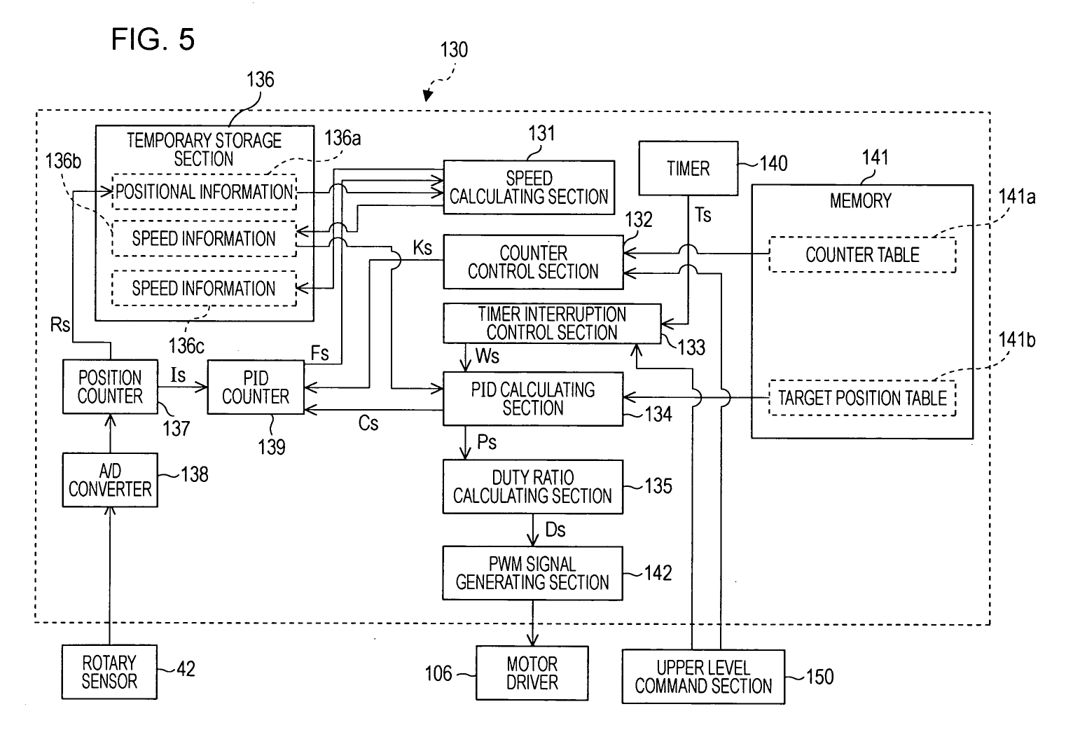

The control section 100 will now be described with reference to FIG. 4, FIG. 5, and the like. The control section 100 is a section that executes various control operations. The control section 100 acquires various output signals input from the rotary sensor 42, the linear sensor 52, the paper width detection sensor (not shown), the gap detection sensor (not shown), a power switch that turns on/off the printer 10, or the like.

As shown in FIG. 1, the control section 100 includes a CPU 101, a ROM 102, a RAM 103, a PROM 104, an ASIC 105, a motor driver 106, and the like, which are connected through a transmission line 107, such as a bus, for example. By cooperation between these pieces of hardware and software and/or data stored in the ROM 102 or the PROM 104, or by adding a circuit or component that executes specific processing, or the like, the configuration (a measurement unit 110 or a corrected output power applying unit 120) shown in the block diagram of FIG. 4 and the configuration (a motor drive control unit 130) shown in the block diagram of FIG. 5 are functionally implemented.

In addition, through the above described cooperation, or the like, an upper level command section 150, that instructs the measurement unit 110, the corrected output power applying unit 120 and the motor drive control unit 130, is also implemented. The upper level command section 150 acquires a detection signal input from the A/D converter 114, or the like, and is capable of determining a current transportation position of the print target P. Note that the upper level command section 150 may be configured to acquire a detection signal Rs input from a position counter 137 shown in FIG. 5.

Note that the measurement unit 110 may be configured to be implemented, for example, when the printer 10 is turned on, and not to be implemented while printing. In addition, it is only necessary that the corrected output power applying unit 120 is implemented in a state where the PID control is not performed (PID control is released). However, the corrected output power applying unit 120 may be configured not to be implemented while printing.

Further, conceptionally, it may be considered that the measurement unit 110, corrected output power applying unit 120 and motor drive control unit 130 are formed in parallel and these units are selectively used, for example, on the basis of instructions from the CPU 101. Alternatively, exclusive circuits may be employed in order to implement the measurement unit 110, corrected output power applying unit 120 and motor drive control unit 130.

As shown in FIG. 4, the measurement unit 110 includes a measurement control section 111, a duty ratio calculating section 112, a PWM signal generating section 113, the A/D converter 114, a measurement section 115, and a memory 116. In other words, the measurement unit 110 has configurations which may be regarded as a storage device, a measurement control device, and a corrected output power calculating device.

The measurement control section 111, which may be regarded as a measurement control device, is a section that, for example, when the printer 10 is turned on, receives instructions from the upper level command section 150 and outputs a control signal Ms relating to a measurement operation in accordance with a predetermined sequence. Note that the measurement control section 111 executes the operation which will be described in the operation flow later. The duty ratio calculating section 112, the PWM signal generating section 113 and the A/D converter 114 are the same as a duty ratio calculating section 135, a PWM signal generating section 142 and an A/D converter 138, which will be described later, and a description thereof is omitted.

The measurement section 115, which may be regarded as a corrected output power calculating device, is a section that, when the PF motor 31 is driven in accordance with the predetermined sequence, measures its operating state and then calculates a corrected output power. As regards measurement of the operating state, there are two ways of measurement as will be described later in the operation flow. Note that the two ways of measurement will be specifically described later.

The memory 116 may be regarded as a storage device. The memory 116 stores reference information (which may be regarded as a reference duty ratio or a reference rotational speed; reference information 116a). In addition, the memory 116 stores corrected output power information 116b.

Meanwhile, as shown in FIG. 4, the corrected output power applying unit 120, which may be regarded as a corrected output power applying device, includes a corrected output power control section 121, the duty ratio calculating section 112, the PWM signal generating section 113 and the memory 116. The corrected output power control section 121 reads the corrected output power information 116b stored in the memory 116, and outputs a control signal Hs corresponding to the corrected output power information 116b to the duty ratio calculating section 112. Note that, because the duty ratio calculating section 112 and the PWM signal generating section 113 are the same as the above described measurement unit 110 and the motor drive control unit 130, which will be described later, a description thereof is omitted. The memory 116 is also the same as the above described measurement unit 110, and a description thereof is omitted as well.

Further, as shown in FIG. 5, the motor drive control unit 130 includes a speed calculating section 131, a counter control section 132, a timer interruption control section 133, a PID calculating section 134, a duty ratio calculating section 135, a temporary storage section (register) 136, a position counter 137, an A/D converter 138, a PID counter 139, a timer 140, a memory 141, a PWM signal generating section 142. The motor drive control unit 130 may be regarded as a motor drive control device.

The speed calculating section 131 calculates a transporting speed of the print target P on the basis of the detection signal Rs that is input through the A/D converter 138. In this case, the number of clock pulses between the adjacent edges of ENC signal shown in FIG. 3A and FIG. 3B is counted by a counter (not shown), and the transporting speed is calculated using the number of counts and a distance between the edges. In addition, when an identification signal Fs is input from the PID counter 139, temporary speed information 136c is calculated using a prescribed period of time until the time expires and a distance between the edges. Note that the calculated transporting speed is stored in the temporary storage section 136 as speed information 136b. In addition, the temporary speed information 136c, as well as the speed information 136b, is also stored in the temporary storage section 136.

The counter control section 132 sets the number of counts of the PID counter 139 on the basis of a counter table 141a stored in the memory 141. Here, the counter table 141a is a table that is defined by the speed information 136b and the number of times the PID calculation is performed. Therefore, the counter control section 132 acquires the speed information 136b input from the temporary storage section 136. However, it is applicable that the counter table 141a is defined by positional information and the number of times the PID calculation is performed or time and the number of times the PID calculation is performed. In this case, positional information 136a is input from the temporary storage section 136. In addition, it is applicable that the number of times the PID calculation is performed may be calculated on the basis of the positional information 136a or the speed information 136b without employing the configuration that the memory 141 stores the counter table 141a.

The timer interruption control section 133, as it receives a timer signal Ts that is output when the timer 140 reaches a preset time, instructs the PID calculating section 134 to execute a calculation for PID control in accordance with the status of interruption of the PID control. Note that, normally, the CPU 101 receives an interruption request signal and executes a calculation for PID control on the basis of the interruption request signal.

The PID calculating section 134 is a section that executes a calculation for PID control when the timer interruption control section 133 instructs (selects) execution of PID control. In the PID control, information relating to a positional deviation is calculated using a target position table 141b that is read out from the memory 141 and the current positional information 136a that is read out from the temporary storage section 136. Then, on the basis of the information relating to the positional information, information relating to a target speed is calculated by multiplying a predetermined gain, or the like. At the time, the PID calculating section 134 may be configured to read out a table relating to the target speed corresponding to the calculated positional deviation from the memory 141.

The PID calculating section 134 calculates a speed deviation on the basis of the target speed and the speed information 136b or the temporary speed information 136c, which is read out from the temporary storage section 136. Then, the PID calculating section 134 calculates a proportional term, an integral term and a derivative term by multiplying the speed deviation by a proportional gain, an integral gain and a derivative gain, respectively. Then, by adding the proportional term, the integral term and the derivative term, a control signal Ps is output. Further, the PID calculating section 134 transmits a count signal Cs to the PID counter 139 every time the PID calculation is performed. Thus, the PID counter 139 updates the number of times the PID calculation is performed.

The duty ratio calculating section 135 calculates a duty ratio on the basis of the control signal Ps. Then, a signal Ds relating to the calculated duty ratio is output to the PWM signal generating section 142.

Further, the positional information 136a, the speed information 136b and the temporary speed information 136c are stored in the temporary storage section 136. The temporary storage section 136 may be used as a register for the ASIC 105; however, when a transfer rate at which various pieces of information are transferred is sufficiently high, it is applicable to store the above various pieces of information in a predetermined storage area, such as the RAM 103. Note that the types of information to be stored in the temporary storage section 136 are not limited to these positional information 136a, speed information 136b and temporary speed information 136c but various types of information may be stored therein.

In addition, the position counter 137, when the detection signal Rs output from the rotary sensor 42 is input through the A/D converter 138, calculates a current position (the positional information 136a) by counting the edges of the detection signal Rs. Then, the calculated positional information 136a is stored in the temporary storage section 136. Note that, when the position counter 137 counts a new edge, the positional information 136a stored in the temporary storage section 136 is updated every count. The A/D converter 138 converts an analog signal output from the rotary sensor 42 to a digital signal.

Further, the PID counter 139 sets the number of times (set number of times) the PID counter 139 counts on the basis of a control signal Ks from the counter control section 132. In addition, the PID counter 139 updates the number of times the PID calculation is performed (the number of PID calculations) on the basis of the count signal Cs output from the PID calculating section 134. Then, as the number of PID calculations reaches the set number of times, the PID counter 139 transmits an identification signal to the speed calculating section 131. Furthermore, the PID counter 139 clears the number of PID calculations to zero as it receives a clear signal Is corresponding to the update of the positional information 136a from the position counter 137. Note that this zero clearing may be executed by receiving an ENC signal from the A/D converter 138.

The timer 140 outputs a timer signal Ts to the timer interruption control section 133 as it reaches a preset time, such as 100 μs, for example.

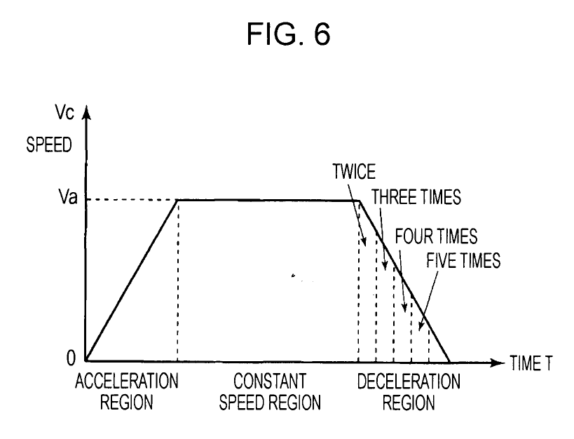

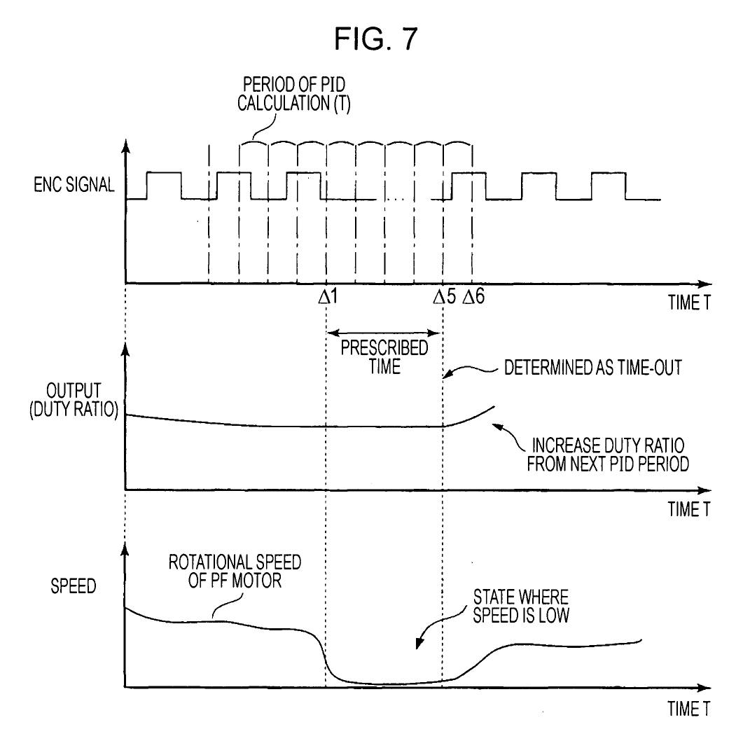

The memory 141 stores a counter table 141a and a target position table 141b. Here, the counter table 141a has a number to be counted, which is set, for example, in correspondence with a speed table shown in FIG. 6. That is, in a state where the number of rotations of the PF motor 31 is large, the position counter 137 detects (counts) the edges of the ENC signal at a short time interval, and the time until the update of the speed information 136b is also short. Therefore, as shown in FIG. 7, as compared to a prescribed period (PID period) in which the PID calculation is performed through timer interruption, the time intervals between the edges are set smaller, the number of PID calculations that the PID counter 139 counts is set smaller (for example, once, twice, or the like), and the period of time until the time expires is set shorter.

In contrast, in a state where the number of rotations of the PF motor 31 is small (the rotational speed is low), the position counter 137 detects (counts) the edges of the ENC signal at a long time interval. Therefore, as shown in FIG. 7, as compared to a prescribed period (PID period) in which the PID calculation is performed through timer interruption, the time intervals between the edges are longer. For this reason, the number of PID calculations that the PID counter 139 counts is set larger (for example, four times, or the like, in FIG. 7), and the period of time until the time expires is set longer. The types of information as described above are contained in the counter table 141a.

In addition, the target position table 141b provides information relating to the target position in the PID control, or the like.

The PWM signal generating section 142 generates a PWM signal on the basis of a signal Ds relating to the above described duty ratio. Note that the PWM signal generating section 142 generates a PWM signal by turning on/off of a switching element. At this time, the PWM signal generating section 142 may be configured to amplify the PWM signal to a predetermined voltage and then supplies the pulse voltage, that has been amplified, to the motor driver 106. Note that the motor driver 106 outputs a pulse voltage supplied from the PWM signal generating section 142 to the PF motor 31. Here, the motor driver 106, for example, includes four transistors, and turning on/off of these transistors allows an operating state to change among a forward rotation state, a reverse rotation state, a braking state, and the like.

### Measurement when Printer is Turned on

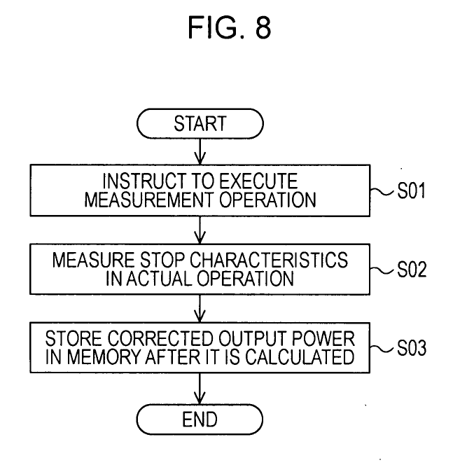

The measurement operation in the above configured printer 10 will now be described with reference to FIG. 8.

When a user turns on the printer 10, the printer 10 starts an initial operation. This initial operation includes a measurement operation. The upper level command section 150 instructs the measurement control section 111 to execute the measurement operation (S01; which may be regarded as a controlling step). Then, the PF motor 31 is driven and, on the basis of the PF motor 31 being driven, the measurement section 115 measures stop characteristics in an actual operation (S02). Here, there are the following two ways of measurement operation regarding the measurement.

The first way is to measure how much a duty ratio with which the PF motor 31 reaches a predetermined rotational speed is different from a reference duty ratio. In this case, the measurement control section 111 may be configured to drive the PF motor 31 to rotate at a just one rotational speed. In addition, the measurement control section 111 may be configured to drive the PF motor 31 to rotate at a first rotational speed and a second rotational speed different from the first rotational speed.

Note that, when the PF motor 31 is rotated at the first rotational speed and the second rotational speed, a differential (actual differential) between an actual duty ratio with which the first rotational speed is achieved and another actual duty ratio with which the second rotational speed is achieved is calculated. In addition, the memory 116 stores in advance a differential (reference differential) between a reference duty ratio in the first rotational speed and another reference duty ratio in the second rotational speed. Because the actual differential deviates from the reference differential when the stop characteristics vary, the stop characteristics is estimated by calculating the deviation between the actual differential and the reference differential, and, on the basis of the estimated stop characteristics, a corrected output power is calculated and then stored in the memory 116 (S03; which may be regarded as a calculating step).

On the other hand, the second way is to measure how much an actual rotational speed of the PF motor 31 deviates from a reference speed that correlates with the reference stop characteristics when the PF motor 31 is applied with a constant duty ratio. In this case, the measurement control section 111 may be configured to drive the PF motor 31 to rotate with a just one duty ratio. In addition, the measurement control section 111 may be configured to drive the PF motor 31 to rotate with a first duty ratio and a second duty ratio different from the first duty ratio. When the PF motor 31 is driven with the first duty ratio and with the second duty ratio, the stop characteristics are estimated on the basis of a deviation between a differential in actual speeds and a differential in reference speeds, and the corrected output power is calculated on the basis of the estimated stop characteristics and then stored in the memory 116 (S03; which may be regarded as calculating step).

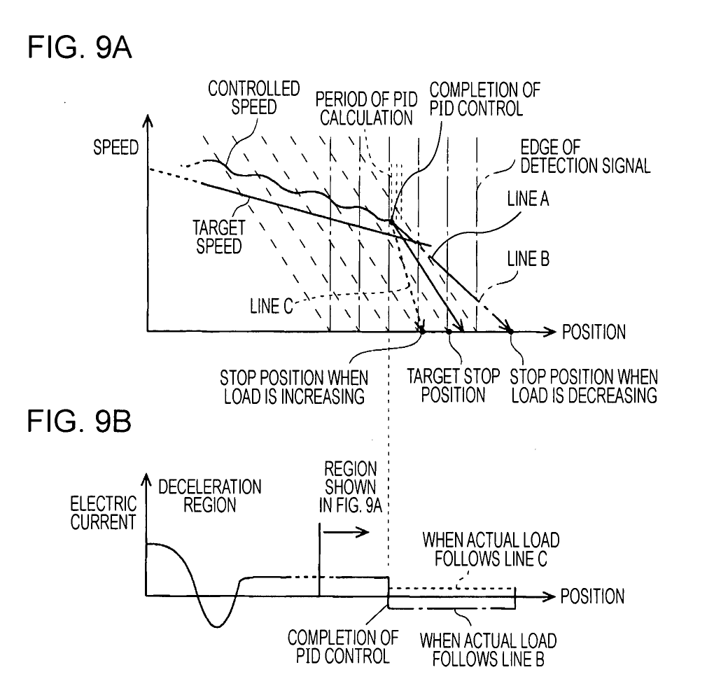

Here, the stop characteristics will be described with reference to FIG. 9A and FIG. 9B. FIG. 9A is a view showing a relationship between speed and position and is a view showing a state around the stop. In FIG. 9A, the line A indicates reference stop characteristics when electric current supplied to the PF motor 31 is interrupted at a point where the PID control is stopped. The line B indicates stop characteristics when in the same situation as the line A but in a state where the load is relatively small. Furthermore, the line C indicates stop characteristics when in the same situation as the line A but in a state where the load is relatively large.

As shown in FIG. 9A, when the stop characteristics change from the line A to the line B, an actual load (dynamic friction) is smaller than a reference load (dynamic friction). Therefore, in this case, the measurement section 115 calculates a corrected output power relating to an electric current value with which the PF motor 31 stops along the line A. Note that the corrected output power calculated in this case applies an electric current value with which the PF motor 31 is rotated in a direction opposite to the transporting direction, and is an output power relating to an electric current indicated by an alternate long and short dash line in FIG. 9B.

In addition, when the stop characteristics change from the line A to the line C, the actual load (dynamic friction) is larger than the reference load (dynamic friction). Therefore, in this case, the measurement section 115 calculates a corrected output power relating to an electric current value with which the PF motor 31 stops along the line A. Note that the corrected output power calculated in this case applies an electric current value with which the PF motor 31 is rotated in the same direction as the transporting direction, and is an output power relating to an electric current indicated by a broken line in FIG. 9B.

As such, the corrected output power is calculated at the measurement section 115 and is stored in the memory 116 as the corrected output power information 116b.

### Whole Printing Operation

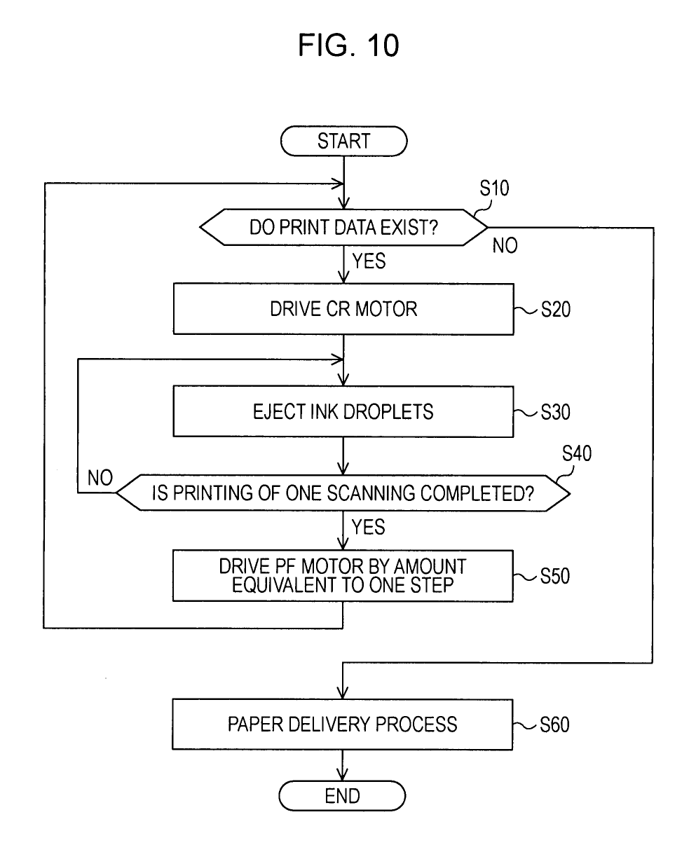

The whole printing operation of the printer 10 having the above described configuration will be described with reference to FIG. 10, and the like.

For example, when a user specifies a high definition print mode and the printer 10 then performs printing, the print target P is transported using a table with which positioning of a stop position of the print target P is highly accurate. In transporting the print target P, the PF motor 31 is driven, for example, on the basis of a speed table as shown in FIG. 6. At this time, the print target P is transported by one scanning by driving the PF motor 31 and printing is then performed.

This operation will be described with reference to FIG. 10. First, the CPU 101 inquires a computer 160 (see FIG. 1) whether there are print data or not (S10). When there are print data, the process proceeds to S20; otherwise, the process proceeds to S60. Subsequently, when there are print data, print data for one line are received from the computer 160 and printing operation is then started. That is, the CR motor 22 is driven on the basis of the instructions from the CPU 101, and the carriage 21 starts reciprocating movement in the main scanning direction (S20).

In addition, the control section 100 controls to drive the print head 28 on the basis of a predetermined timing signal PTS and the above print data. Thus, the ink discharging process, in which ink droplets are discharged from the nozzles of the print head 28, is performed (S30). Note that, by discharging ink droplets, printing for one scanning is performed on the print target P.

Next, the CPU 101 determines whether the printing process for one scanning is completed or not (S40). In this S40, when it is determined that the printing process is completed, the process proceeds to S50; otherwise, the process goes back to S30 and repeats the same process.

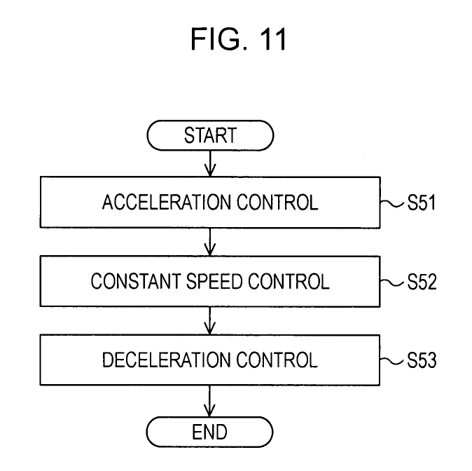

In this manner, as the printing operation for one line is completed, the CPU 101 drives the PF motor 31 to move the print target P in the auxiliary scanning direction by one step (S50). Note that the details of S50 will be described with reference to FIG. 11, and the like. Then, the CPU 101 returns the process to S10 and repeats the same processes. That is, the CPU 101 executes, on the basis of the next print data for one line, a process for printing the print data through the same processes described above. Repeating these processes, it is possible to print a desired image onto the print target P.

In addition, when it is determined that there are no print data in S10 (NO in S10), the CPU 101 drives the PF motor 31 to execute a process to deliver the print target P (S60). As a result, the print target P that has completed printing is delivered outside of the printer 10.

### Overview of Drive Control of PF Motor 31

The overview of drive control of the PF motor 31 (the detail of S50) will be described with reference to FIG. 11. In this drive control, the CPU 101, in accordance with a predetermined process sequence, sends a control signal to the ASIC 105 to execute acceleration control of the PF motor 31 as shown in a speed table of FIG. 6 (S51). Subsequent to this acceleration control, the CPU 101 sends a control signal to the ASIC 105 to execute constant speed control of the PF motor 31 as shown in the speed table of FIG. 6 (S52).

Similarly, the CPU 101 sends a control signal to the ASIC 105 to execute deceleration control of the PF motor 31 as shown in the speed table of FIG. 6 (S53). Then, as this deceleration control is completed, the PF motor 31 enters a stop driving state and the print target P is transported by one scanning. Note that, when there are print data after the PF motor 31 enters a stop driving state, the CR motor 22 is driven to move the carriage 21 (the above S20). Note that in these steps S51 to S53, the speed information 136b that is temporarily stored in the temporary storage section 136 is updated on the basis of the detection signal Rs where appropriate.

### Detail of Deceleration Control

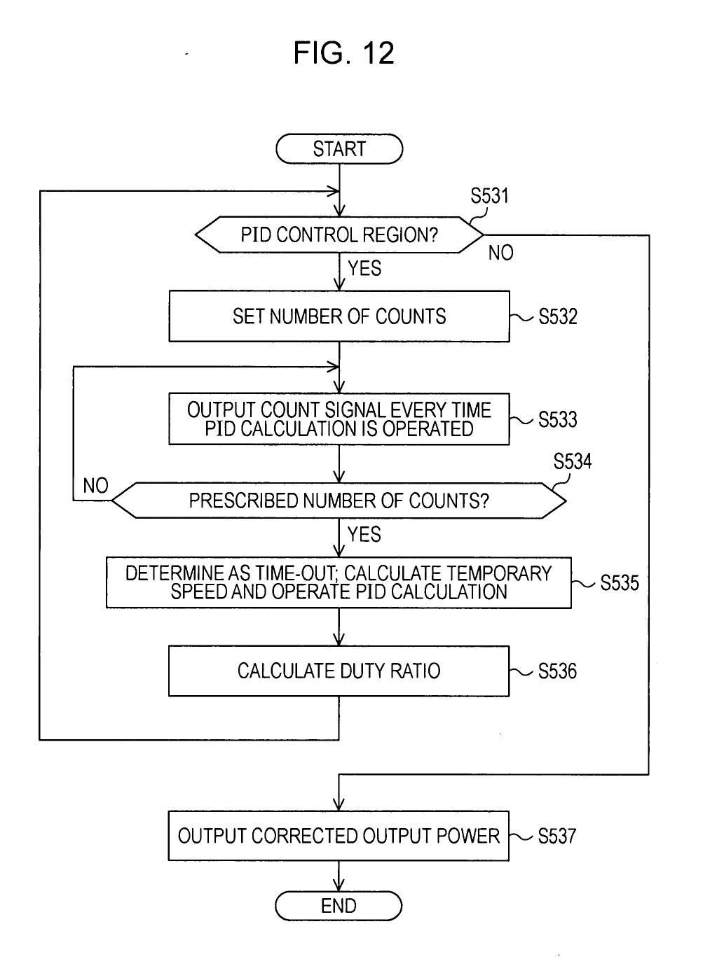

The detail of deceleration control of the PF motor 31 in the above S53 will be described with reference to FIG. 12, or the like. In a deceleration region shown in FIG. 6, the CPU 101 first determines whether it is in a PID control region or not (S531). When the determination is Yes, the CPU 101 executes a process for PID control and then outputs a control signal to the ASIC 105.

Here, in the PID control, the counter control section 132 reads a counter table 141a, in which the number of counts corresponding to a speed in the speed table of FIG. 6 is stored, and sets the number of counts for the PID counter 139 (S532). Then, the PID calculating section 134 transmits the count signal Cs to the PID counter 139 every time the PID calculation is performed (S533). After that, it is determined whether the number of counts in the PID counter 139 reaches a prescribed number of counts or not (S534).

Here, when the number of counts has reached a prescribed number of counts (Yes in S534) and when Δ1 to Δ5 in FIG. 7 are defined as a prescribed period of time, the position counter 137 has not completed counting the edges of the ENC signal within the prescribed period of time and the speed information 136b has not been updated. That is, if the PF motor 31 is rotated at a designated number of rotations, the position counter 137 completes counting the edges of the ENC signal within the prescribed period of time, and the clear signal Is is input in the PID counter 139. Therefore, in the PID counter 139, the number of counts is cleared to zero and should not reach a prescribed number of counts. However, when Yes in S534, the number of rotations of the PF motor 31 is extremely low more than expected or the rotation is stopped, causing the position counter 137 not to count the edges of the ENC signal. For example, when the PID calculation is performed with a period of 100 μs in FIG. 7 and the PID calculation is performed five times from Δ1 to Δ5, no edges of the ENC signal are counted at all for 400 μs.

Then, when Yes in S534, it is determined that the time has expired, so that the control is executed for increasing the number of rotations of the PF motor 31. That is, in this case, the PID calculation is performed in the speed calculating section 131 and the PID calculating section 134 using a prescribed period of time until the time expires. At this time, the speed calculating section 131 calculates the temporary speed information 136c using a prescribed distance between the adjacent edges and a prescribed period of time until the time expires. Then, the prescribed period of time until the time expires is set sufficiently longer than the time assumed in the speed table in FIG. 6, so that the calculated temporary speed information 136c indicates a sufficiently low speed. Note that the temporary speed information 136c is not overwritten onto the speed information 136b of the temporary storage section 136 but is stored at another portion in the temporary storage section 136. The PID calculating section 134 executes a PID calculation using the calculated temporary speed information 136c (speed information that indicates a sufficiently low speed) (S535). The prescribed period of time until the time expires may be stored in the counter table 141a together, and it may be stored separately as an exclusive table in the memory 141.

Then, a duty ratio is calculated on the basis of the control signal Ps output from the PID calculating section 134 (S536). In this case, a deviation from the target speed becomes large when using the temporary speed information 136c that indicates a sufficiently low speed, so that, when a duty ratio is calculated on the basis of the control signal Ps output from the PID calculating section 134, a sufficiently large duty ratio may be obtained in comparison with a speed assumed in the speed table of FIG. 6. The PWM signal corresponding to this duty ratio is applied through the motor driver 106 to the PF motor 31.

On the other hand, when it is determined that a prescribed number of counts is not reached in S534 (NO in S534), the process goes back to S533 and continues the above processes.

After the above S536, the process goes back to the above S531. Then, when it is determined that it is not in the PID control region in S531 (No in S531), it is not in the PID control region but may be transferred to a region in which another control is executed or the speed control is completed. Note that this determination in S531 may be executed when driving of the PF motor 31 falls into a predetermined portion in the speed table. In addition, the determination in S531 may be executed when the above described paper end detection sensor 36 has detected passing of the rear end of the print target P and paper feed is performed by predetermined steps after that passing.

When No in the above S531, the PID control is completed. As the PID control is completed, subsequently, the following corrected output power is output (S537).

The deceleration control is executed as described above. When the above described deceleration control is executed, even when the rotational speed of the PF motor 31 is in a low region, the PID control may be executed while preventing stalling.

### Detail of Output of Corrected Output Power

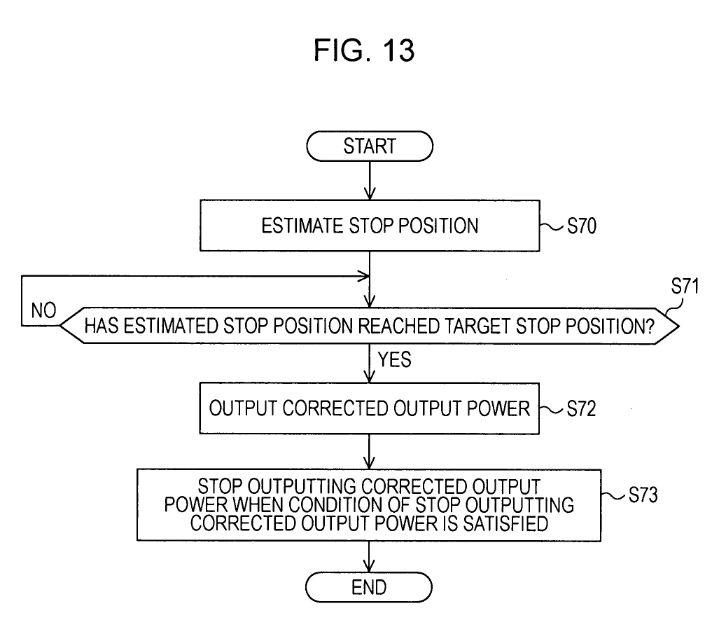

The detail of output of the corrected output power in the above S538 will be described with reference to FIG. 13. When the corrected output power is output, the corrected output power control section 121 estimates a position at which the print target P will stop using the current speed information on the basis of the reference stop characteristics (characteristics indicated by the line A in FIG. 9) (S70). Then, it is determined whether the estimated stop position is located, if only a little, over the target position or not (S71). In this determination, when the estimated stop position is located, if only a little, over the target position (Yes in S71), it is determined that the stop condition is satisfied, so that the PID control is stopped, and the corrected output power control section 121 outputs the corrected output power (S72; which may be regarded as an outputting step). In this case, the corrected output power control section 121 reads the corrected output power information 116b stored in the memory 116 and outputs the control signal corresponding to the corrected output power information 116b to the duty ratio calculating section 112.

Then, the duty ratio calculating section 112 calculates a duty ratio on the basis of the control signal Hs. The duty ratio calculating section 112 outputs the signal Ds relating to the calculated duty ratio to the PWM signal generating section 113. The PWM signal generating section 113 applies a PWM signal corresponding to the calculated duty ratio through the motor driver 106 to the PF motor 31. The PF motor 31 is then supplied with electric current as shown in FIG. 9B. In this case, when the stop characteristics are indicated by the line B, the actual load (dynamic friction) is smaller than the reference load. Hence, electric current is supplied to generate a force in a direction to increase the load (in a direction opposite to the transporting direction).

Note that the corrected output power is output after the edge of the detection signal Rs is detected for the first time after it is determined that the estimated stop position is located, if only a little, over the target position, and, in addition, after the last period in which the PID calculation is performed has elapsed. In addition, in the determination in S71, when it is determined that the estimated stop position is not located over the target position (No in S71), the determination in S71 is continued.

On the other hand, when the stop characteristics are indicated by the line C, the actual load (dynamic friction) is larger than the reference load. Hence, electric current is supplied to generate a force in a direction to reduce the load (in the same direction as the transporting direction).

By applying the above described corrected output power (electric current), the PF motor 31 is reduced in speed along the stop characteristics indicated by the line A and is finally stopped. When the edge of the detection signal Rs is not detected by a detection portion (not shown) within a prescribed period of time or when a condition of stop outputting power, such as when a prescribed period of time has elapsed, is satisfied, an output of the corrected output power (electric current) is stopped (S73).

### Advantageous Effects According to the Aspects of the Invention

With the above configured printer 10, the measurement unit 110 calculates a corrected output power. Then, the corrected output power applying unit 120, when the print target P satisfies a condition of stopping, stops driving by the PID control and applies the corrected output power to the PF motor 31. Therefore, for example, even when the printer 10 is used over time and the stop characteristics then vary, it is possible to stop the motor so as to follow the reference stop characteristics. In this manner, even when the printer 10 is used for a long time, it is possible to stop the print target P at a position that is not significantly deviated from the target position and also possible to ensure the accuracy of the stop position. In addition, because it is not necessary to, for example, decrease the rotational speed of the PF motor 31 in order to improve the accuracy of the stop position, throughput may be improved.

In particular, in the present embodiment, the stop position is estimated on the basis of the current rotational speed (the number of rotations) of the PF motor 31 and the reference stop characteristics. Therefore, it is possible to estimate the stop position of the print target P, irrespective of the current rotational speed (the number of rotations) of the PF motor 31, and it is possible to ensure the accuracy of the stop position of the print target P. In addition, because it is determined that the stop condition is satisfied when the estimated stop position of the print target P is equal to or beyond the target stop position of the print target P, it is possible to prevent such a drawback that the print target P stops immediately before the target stop position and the print target P thereby cannot be delivered, for example.

Furthermore, the upper level command section 150 interrupts electric current supplied through the PID control when the estimated stop position is equal to or beyond the target stop position on the basis of the detection signal input from the A/D converter 114. After the interruption of supply of electric current, because the corrected output power is output, it is possible to ensure the accuracy of the stop position of the print target P. In addition, by so estimating the stop position, even when the transport speed of the print target P is an assumed speed or above, it is possible to stop the print target P around the target position.

Moreover, in the present embodiment, the measurement unit 110 measures actual stop characteristics of the PF motor 31 when the printer 10 is turned on, that is, an initial start-up of the printer 10. For this reason, a printing operation is not interrupted as compared with the case where the actual stop characteristics of the PF motor 31 are measured during a printing operation, and it is possible to prevent influencing the throughput.

Further, the measurement section 115 is able to calculate the corrected output power by comparing an actual duty ratio by which the PF motor 31 is driven at a target speed with a reference duty ratio that correlates with the reference stop characteristics. In this case, it is possible to calculate the corrected output power in response to the actual driving of the PF motor 31.

Still further, the measurement section 115 is able to calculate the corrected output power by comparing an actual speed at which the PF motor 31 is driven by a constant duty ratio with a reference speed that correlates with the reference stop characteristics. In this case, it is possible to calculate a variation in load on the PF motor 31 using a variation in speed.

The embodiment of the invention is described above, but it may be modified into various alternative embodiments as exemplified below.

The above embodiment is described using the PF motor 31, which is regarded as a motor for which the control according to the invention is executed. However, the motor for which the control according to the invention is executed is not limited to the PF motor 31, but the motor may be the CR motor 22, an ASF motor, a pump motor, a platen gap adjustment motor, or the like, other than the PF motor 31, included in the printer 10.

In addition, in the above embodiment, the control section 100 includes the CPU 101 and the ASIC 105. However, the control section 100 may be configured so that only the ASIC governs a control of the PF motor 31, or the control section 100 may also be configured so that the above CPU 101 and ASIC 105 are combined with a one-chip microcomputer including various built-in peripheral devices, or the like.

The transport object and the print target P in the above described embodiment may be, for example, a label face of a CD-R, or the like, other than paper. In this case, because the CD-R is mounted on a tray, or the like, the mounting portion corresponds to a tray, or the like, for mounting the CD-R.

In addition, in the above described embodiment, the measurement unit 110, for example, operates at the time when the printer 10 is turned on and does not operate while printing. However, the measurement unit may be configured to operate while printing.

Also, in the above embodiment, the corrected output power is applied at the time when the PID control is completed. However, the corrected output power may be overlappingly applied not only at the time when the PID control is completed but also during the PID control.

Yet furthermore, in the above embodiment, in the deceleration region of the PF motor 31, the number of times the PID calculation is performed is counted. Then, on the basis of the counting, it is determined that update of the speed information 136b is a time-out or not, and, when it is determined as a time-out, a duty ratio is increased. However, in the tables of FIG. 5, it may be configured that the same control is executed not only in the deceleration region but also in the acceleration region and/or constant speed region.

Furthermore, in the above embodiment, when it is determined that a prescribed number of times the PID calculation is performed is reached to a time-out, a speed is calculated using the period of time until the time expires. On the basis of this speed, the PID calculation is performed and a duty ratio is calculated. However, for example, when a prescribed number of times that the PID calculation has reached and it is determined as a time-out, it may be configured to apply a predetermined duty ratio. In this case, it is preferable that a table relating to a duty ratio to be applied (applied duty ratio) is stored in the memory 141. In this case, even when a duty ratio is increased because of determination of the time-out and the PF motor 31 still does not start to move, it is possible to gradually add a duty ratio, for example, by further applying a duty ratio. Therefore, even when an extremely large load is exerted on the PF motor 31, it is possible to cause the PF motor 31 to move.

Note that this added duty ratio may be a fixed value, not depending on the magnitude of a duty ratio on the basis of the control signal Ps from the PID calculating section 134, or a value of the added duty ratio may also be discretely or continuously varied depending on the magnitude of a duty ratio on the basis of the control signal Ps.

The above embodiment is described using the PID counter 139 as a counting device. However, the counting device is not limited to the PID counter 139, but it may be another counter or a timer. As an example of another counter or timer, there is a timer that outputs a timer signal when a set predetermined time has elapsed since the edge of the detection signal Rs is detected. In this case, as the timer signal is output, it is determined as a time-out and the same control as the above described embodiment is executed.

What is claimed is:

1. A printer that performs printing on a print target, comprising:
a motor that applies a driving force for transporting a transport object;
a storage device that stores reference information relating to reference stop characteristics of the motor;
a measurement control device that controls driving of the motor for measuring actual stop characteristics of the motor;
a corrected output power calculating device that outputs a corrected output power by comparing the actual stop characteristics with the reference stop characteristics when the measurement control device controls driving of the motor; and
a corrected output power applying device that outputs the corrected output power to the motor so that a stop condition of stopping the transport object is satisfied.

2. The printer according to claim 1, wherein the corrected output power applying device, when the motor is being driven, estimates a stop position, at which the transport object that is transported by the motor stops, on the basis of current speed information relating to the motor and the reference stop characteristics, and, when it is determined that the stop condition is satisfied, that is, the estimated stop position is equal to or beyond a target stop position of the transport object, the corrected output power applying device interrupts electric current for driving the motor and outputs the corrected output power to the motor.

3. The printer according to claim 2, further comprising:
a motor drive control device that, when the motor is being driven, executes PID control on the motor, wherein a PID calculation is performed by the PID control every predetermined period; and
a position detection device that detects a feed amount by which the motor feeds the transport object and that outputs a detection signal, which is a digital signal, to the motor drive control device, wherein
the motor drive control device interrupts electric current supplied through the PID control when the estimated stop position is equal to or beyond the target stop position.

4. The printer according to claim 1, wherein the measurement control device measures the actual stop characteristics when the printer is turned on, that is, an initial start-up of the printer.

5. The printer according to claim 1, wherein the corrected output power calculating device calculates the corrected output power by comparing an actual duty ratio by which the motor is driven at a target speed with a reference duty ratio that correlates with the reference stop characteristics.

6. The printer according to claim 1, wherein the corrected output power calculating device calculates the corrected output power by comparing an actual speed at which the motor is driven by a constant duty ratio with a reference speed that correlates with the reference stop characteristics.

7. The printer according to claim 1, wherein the transport object is the print target, and the motor is a transporting motor that applies a driving force for transporting the print target.

8. A printing method that executes printing on a print target, comprising:
controlling driving of a motor, that applies a driving force for transporting a transport object, to measure actual stop characteristics of the motor;
calculating a corrected output power, when the motor is being driven in the controlling step, by comparing the measured actual stop characteristics with reference stop characteristics stored in a storage device; and
outputting the corrected output power, that is calculated in the calculating step, to the motor so that a stop condition of stopping the transport object is satisfied.
